(19) United States
(12) Patent Application Publication
(10) Pub. No.: US 2018/0022619 A1
(43) Pub. Date: Jan. 25, 2018

(54) SYSTEMS AND METHODS FOR REDUCING MEMBRANE CREEP IN WATER FILTRATION SYSTEMS

(71) Applicant: Aqua Tru, LLC, Sherman Oaks, CA (US)

(72) Inventors: Peter G. Spiegel, Sherman Oaks, CA (US); Michael A. Pedersen, Sherman Oaks, CA (US)

(73) Assignee: Aqua Tru, LLC, Sherman Oaks, CA (US)

(21) Appl. No.: 15/215,904

(22) Filed: Jul. 21, 2016

(51) Int. Cl. C02F 1/00; B01D 61/58; B01D 61/02; C02F 1/44; C02F 1/28

(52) U.S. Cl. CPC C02F 1/002; C02F 1/441; C02F 1/442; C02F 1/283; B01D 61/025; B01D 61/027; B01D 61/58; C02F 2101/10

(57) ABSTRACT

A water filtration system may include a first receptacle configured to store source water, a second receptacle configured to store supply water, an RO filter disposed between the first receptacle and the second receptacle, and a bypass line configured to provide water from the RO filter back to the first receptacle for an initial predetermined amount of time, after which the bypass line is closed and the filtered water is provided to the second receptacle.

### FIELD OF THE DISCLOSURE

The disclosure generally relates to water filtration and more particularly relates to systems and methods for reducing membrane creep in water filtration systems.

### BACKGROUND

Due to increased levels of toxicity caused by chemicals found within the water supply, water filtration has become widespread within many homes. Point-of-use (POU) water treatment devices are designed to treat small amounts of drinking water for use in the home. These devices can sit on the counter, attach to the faucet, or be installed under the sink. They differ from point-of-entry (POE) devices, which are installed on the water line as it enters the home and treats all the water in the building.

Many households today have reverse-osmosis (RO) units installed. RO devices are usually installed underneath the sink, with the tap water connection plumbed directly to the sink cold water supply line, and a waste water drain line connected directly to the sink p-trap. These devices use a membrane that screens out chemicals, such as chloride and sulfate as well as most other contaminates found in the water supply today. A RO system can remove particles down to 1 Angstrom. However POU RO systems can waste as much as 3 to 4 gallons of water for every gallon that is treated. This is due to a continuous flow of water that is required across the membrane surface to remove contamination and to keep the membrane from clogging up.

Solute (e.g., salt or other dissolved solids) may creep across an RO system when there is no water flow across the membrane. In such instances, the solvent naturally moves from an area of low solute concentration (high water potential), through the membrane, to an area of high solute concentration (low water potential). For example, during this state, salt from a high concentrate brine side of the membrane will travel across the membrane to the low salt side due to the osmotic potential. On residential under the sink POE systems, this could happen when pressure is removed from the membrane during filter change or when the clean water tank is full and the pressure on either side of the RO membrane equalizes.

POU systems do not have the benefit of a pressurized clean water tank or permanent tap water pressure as in a under the sink POE RO system. When the POU system stops producing water, the clean side of the membrane will have no pressure due to the stoppage of the pump, and the pressure on the brine side will dissipate over time. Due to this, the salt concentration on the clean side of the membrane will increase. This high concentrate salt water will flow into the clean water tank as soon as the unit starts producing water, thereby increasing the average total dissolved solid (TDS) concentration of the clean water. Testing has shown that the TDS can increase substantially in certain use situations due to salt creep when the unit is not producing water.

### SUMMARY

Some or all of the above needs and/or problems may be addressed by certain embodiments of the water filtration system disclosed herein. According to an embodiment, a water filtration system may include a first receptacle configured to store source water, a second receptacle configured to store supply water, an RO filter disposed between the first receptacle and the second receptacle, and a bypass line configured to provide water from the RO filter back to the first receptacle for an initial predetermined amount of time, after which the bypass line is closed and the filtered water is provided to the second receptacle.

Other features and aspects of the water filtration system will be apparent or will become apparent to one with skill in the art upon examination of the following figures and the detailed description. All other features and aspects, as well as other system, method, and assembly embodiments, are intended to be included within the description and are intended to be within the scope of the accompanying claims.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 schematically depicts a water filtration system in accordance with one or more embodiments of the disclosure.

FIG. 2 schematically depicts a water filtration system in accordance with one or more embodiments of the disclosure.

FIG. 3 schematically depicts a partially exploded view of a water filtration system in accordance with one or more embodiments of the disclosure.

FIG. 4 schematically depicts a water filtration system in accordance with one or more embodiments of the disclosure.

FIG. 5 schematically depicts a water filtration system in accordance with one or more embodiments of the disclosure.

FIG. 6 schematically depicts a partially exploded view of a water filtration system in accordance with one or more embodiments of the disclosure.

FIG. 7 schematically depicts a water filtration system in accordance with one or more embodiments of the disclosure.

FIG. 8 is a flow diagram depicting an illustrative method for filtering water in accordance with one or more embodiments of the disclosure.

FIG. 9 schematically depicts an RO membrane in accordance with one or more embodiments of the disclosure.

FIG. 10 schematically depicts a water filtration system in accordance with one or more embodiments of the disclosure.

FIG. 11 schematically depicts a water filtration system in accordance with one or more embodiments of the disclosure.

FIG. 12 schematically depicts a water filtration system in accordance with one or more embodiments of the disclosure.

FIG. 13 schematically depicts a water filtration system in accordance with one or more embodiments of the disclosure.

FIG. 14 schematically depicts a water filtration system in accordance with one or more embodiments of the disclosure.

### DETAILED DESCRIPTION

### Point-of-Use Water Treatment Devices, Systems, and Methods

Described below are embodiments of a water filtration system (as well as individual components of the water filtration system). Methods of using the water filtration system are also disclosed. In some instances, the water filtration system may comprise a countertop reverse osmosis water filtration system. The water filtration system may provide the technical advantage and/or solution of working independent from any water source and/or drain. That is, the water filtration system may have no external connections. Moreover, the water filtration system may provide the technical advantage and/or solution of little to no waste water. In addition, the water filtration system may provide the technical advantage and/or solution of limiting and/or preventing membrane creep. These and other technical advantages and/or solutions will become apparent throughout the disclosure.

In certain embodiments, the water filtration system may include a support base. The support base may be configured to support the various components of the water filtration system. For example, a first receptacle may be detachably disposed on the support base. The first receptacle may be configured to store source water therein. For example, a user may pour water into the first receptacle, or a user may remove the first receptacle from the support base and fill it with water. In this manner, the first receptacle may include a fill opening configured to receive the water. In some instances, the first receptacle may include an openable lid configured to open and close for providing access to the fill opening. In addition, the first receptacle may include an outlet port and an inlet port.

The water filtration system may include a second receptacle. The second receptacle may be detachably disposed on the support base. The second receptacle may be configured to store supply water therein. In certain embodiments, the second receptacle may include a dispense opening configured to deliver the supply water to a user. In some instances, the second receptacle may include a dispense actuator configured to open and close access to the dispense opening. In this manner, a user may dispense the supply water from the second receptacle. In some instances, the supply water may be used as drinking water. In addition, the second receptacle may include an inlet port.

A filter system may be disposed between the first receptacle and the second receptacle. The filter system may include an inlet port, a first outlet port, and a second outlet port. In some instances, when the first and second receptacles are attached to the support base, the outlet port of the first receptacle may be disposed in fluid communication with the inlet port of the filter system. Moreover, the first outlet port of the filter system may be disposed in fluid communication with the inlet port of the first receptacle. In addition, the second outlet port of the filter system may be disposed in fluid communication with the inlet port of the second receptacle.

In certain embodiments, the filter system may include a number of filters. For example, the filter system may include a first filter, a second filter, and a third filter. The first filter may be configured and disposed to receive water from the inlet port of the filter system and to filter and deliver first filtered water to the second filter. In some instances, the first filter may be a sediment filter or a combination of a sediment filter and a carbon filter. Additional filters may be disposed upstream of the first filter.

The second filter may be configured and disposed to receive the first filtered water from the first filter and to deliver a first portion of the first filtered water to the first outlet port of the filter system. In this manner, the first portion of the first filtered water may comprise waste water that is delivered back to the first receptacle. Moreover, the second filter may be configured to filter and deliver a second portion of the first filtered water to the third filter. The second portion of the first filtered water may comprise second filtered water. In some instances, the second filter may be a reverse osmosis membrane type filter or a nano-filter. In certain embodiments, one or more filters (e.g., the first filter) may be disposed upstream of the second filter. In some instances, one or more filters (e.g. the third filter) may be disposed downstream of the second filter. In yet other embodiments, no filters may be disposed downstream of the second filter.

The third filter may be configured and disposed to receive the second filtered water from the second filter and to filter and deliver third filtered water to the second outlet port of the filter system. In this manner, the third filtered water may comprise the supply water that is delivered to the second receptacle. In some instances, the third filter may be a carbon filter. In other instances, the third filter may be omitted. In such instances, the second filter may be configured to filter and deliver the second portion of the first filtered water to the second receptacle. In yet other instances, additional filters may be disposed downstream of the third filter before the second receptacle.

In certain embodiments, 100% of the water that enters the first filter may pass to the second filter. In another embodiment, less than 100% of the water that enters the second filter may pass to the third filter. For example, about 1% to about 30% of the water that enters the second filter may pass to the third filter, with the remaining water constituting the waste water that is delivered back to the first receptacle. In yet another embodiment, 100% of the water that enters the third filter may pass to the second receptacle. Any percentage of water may enter the first filter, the second filter, or the third filter.

The water filtration system may include a flow restrictor. The flow restrictor may be disposed between and in fluid communication with the first outlet port of the filter system and the inlet port of the first receptacle. The flow restrictor may be configured to create a back pressure on the reverse osmosis membrane. The back pressure may enable the second portion of the first filtered water to pass through the reverse osmosis membrane to produce the second filtered water. Moreover, a return check valve may be disposed between and in fluid communication with the flow restrictor and the inlet port of the first receptacle. The return check valve may be configured to prevent water flow from the first receptacle to the reverse osmosis membrane.

In certain embodiments, a forward check valve may be disposed between and in fluid communication with the second outlet port of the filter system and the inlet port of the second receptacle. The forward check valve may be configured to prevent water flow from the second receptacle to the filter system.

The water filtration system may include a pump disposed between and in fluid communication with the outlet port of the first receptacle and the inlet port of the filter system. In some instances, the pump may be automatically primed by the fluid flow from the outlet port of the first receptacle. For example, the water supplied to the pump may be gravity fed from the outlet port of the first receptacle. The pump may be the sole source for generating hydraulic pressure that facilitates fluid flow from the first receptacle through the filter system to the second receptacle. The pump may facilitate fluid flow from the first receptacle through only a portion of the filter system back to the first receptacle via the flow restrictor.

The water filtration system may include additional components and functionality. For example, the water filtration system may include a UV treatment device, a heater, a chiller, and/or a carbonator. In addition, the water filtration system may include devices capable of adding vitamins to the water and/or re-mineralizing the water.

In certain embodiments, the water filtration system may include a supply of electrical power, an electronic controller, a first sensor disposed and configured to sense a water level in the first receptacle, and a second sensor disposed and configured to sense a water level in the second receptacle. The electronic controller may be disposed in signal communication with the supply of electrical power, the first sensor, the second sensor, and the pump. In some instances, the electrical controller may be configured to sense (via the first sensor) a water level in the first receptacle sufficient enough to enable activation of the pump. The electrical controller also may be configured to sense (via the second sensor) a water level in the second receptacle deficient enough to enable activation of the pump. Moreover, the electrical controller may be configured to activate or deactivate the pump in accordance with the respective water levels in the first and second receptacles.

The supply of electrical power may include an electrical cord connectable to an alternating current (AC) line voltage. In some instances, the AC line voltage may be 120 VAC. In other instances, the supply of electrical power may include at least one direct current (DC) battery. The at least one DC battery may be configured to provide 12 VDC or 24 VDC. The supply of electrical power may include an electrical input port configured to receive a DC voltage.

These and other embodiments of the disclosure will be described in more detail through reference to the accompanying drawings in the detailed description of the disclosure that follows. This brief introduction, including section titles and corresponding summaries, is provided for the reader's convenience and is not intended to limit the scope of the claims or the proceeding sections. Furthermore, the techniques described above and below may be implemented in a number of ways and in a number of contexts. Several example implementations and contexts are provided with reference to the following figures, as described below in more detail. However, the following implementations and contexts are but a few of many.

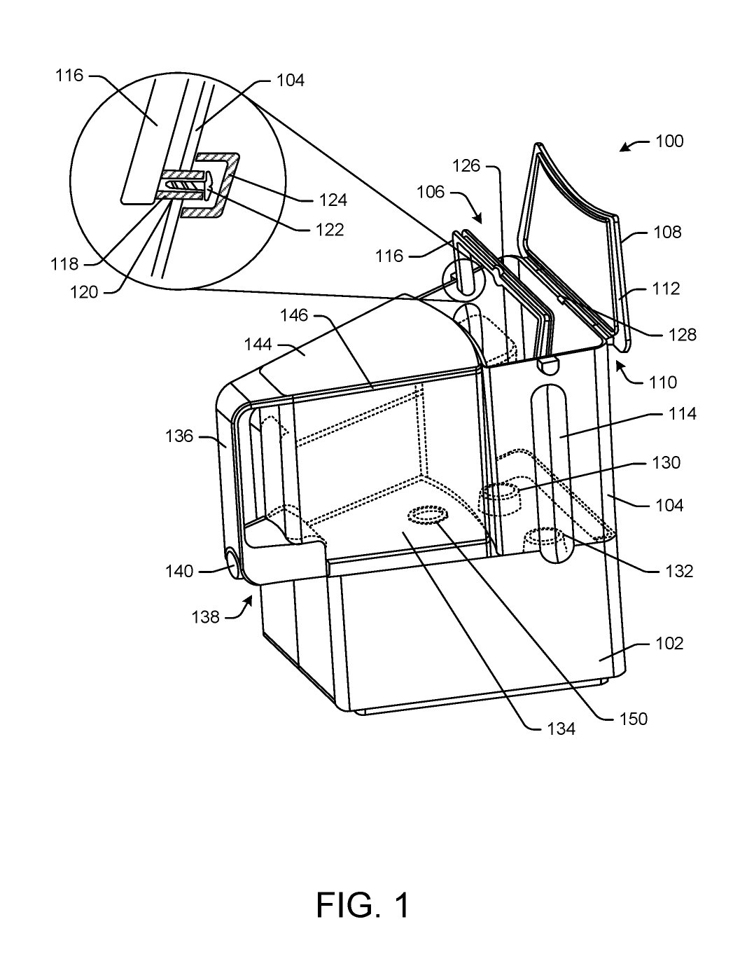

FIGS. 1-7 schematically depict a water filtration system 100 (as well as individual components of the water filtration system 100) in accordance with one or more embodiments of the disclosure. In some instances, the water filtration system 100 may comprise a countertop reverse osmosis water filtration system. That is, the water filtration system 100 may be sized and shaped to fit on a countertop and/or within a refrigerator. The water filtration system 100 may be any suitable size and shape. The water filtration system 100 may work independent from any water source and/or drain. That is, the water filtration system 100 may have no external connections. Moreover, the water filtration system 100 may produce little to no waste water.

In certain embodiments, as depicted in FIG. 1, the water filtration system 100 may include a support base 102. The support base 102 may be configured to support and/or house the various components of the water filtration system 100. For example, a first receptacle 104 may be detachably disposed on the support base 102. The first receptacle 104 may be configured to store source water therein. For example, a user may pour water (e.g. tap water) into the first receptacle 104, or a user may remove the first receptacle 104 from the support base 102 and fill it with water (e.g., tap water). In this manner, the first receptacle 104 may include a fill opening 106 configured to receive the water. In some instances, the first receptacle 104 may include an openable lid 108. The openable lid 108 may be configured to open and close for providing access to the fill opening 106. In one example, the openable lid 108 may be attached to the first receptacle 104 by way of a hinge 110 or the like. In some instances, the openable lid 108 may form a lip 112 about the first receptacle 104. A user may engage the lip 112 to open and close the openable lid 108. In addition, the first receptacle 104 may include vertical grooves 114 on each side.

The first receptacle 104 also may include a handle 116. In some instances, the handle 116 may be in rotatable communication with the first receptacle 104. For example, the handle 116 may be attached to an inner portion of the first receptacle 104. That is, the handle 116 may include a protrusion 118 (e.g., a threaded portion) extending through a hole 120 in the first receptacle 104. A fastener 122 (e.g., a screw) may be disposed (or threaded) into the protrusion 118. In some instances, a cap 124 may be disposed over the fastener 122. The handle 116 may include a stop 126 configured to engage a notch 128 in the first receptacle 104. The stop 126 and notch 128 may limit the rotation of the handle 116.

The first receptacle 104 may include an outlet port 130 and an inlet port 132. In some instances, water may exit the first receptacle 104 through the outlet port 130. Water also may enter the first receptacle 104 by way of the inlet port 132.

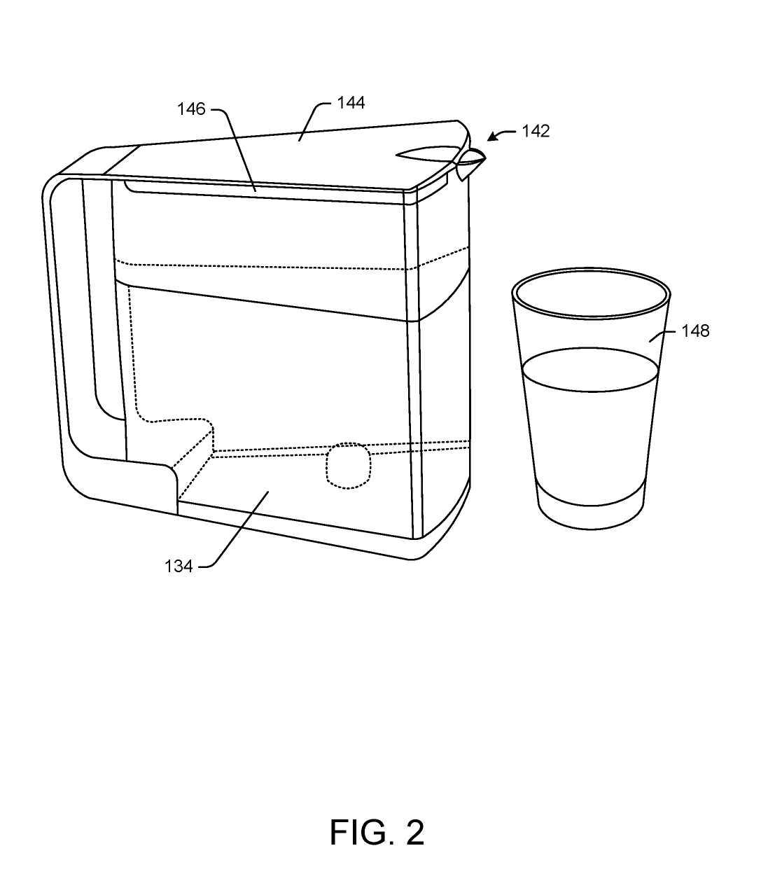

The water filtration system 100 may include a second receptacle 134. The second receptacle 134 may be detachably disposed on the support base 102. In some instances, the second receptacle 134 may include a handle 136 for removing and inserting the second receptacle 134 to the support base 102. The second receptacle 134 may be configured to store supply water (e.g., filtered drinking water) therein. In certain embodiments, the second receptacle 134 may include a dispense opening 138 configured to deliver the supply water to a user. In some instances, the second receptacle 134 may include a dispense actuator 140 configured to open and close access to the dispense opening 138. In one example embodiment, the dispense actuator 140 may be disposed on the handle 136. In this manner, a user may dispense the supply water from the second receptacle 134. In other instances, as depicted in FIG. 2, a user may dispense the supply water from an opening 142 disposed about a lid 144 of the second receptacle 134. In some instances, the lid 144 may be removable from the second receptacle 134. The lid 144 also may form a lip 146 about the second receptacle 134. In some instances, the supply water may be used as drinking water. For example, a user may dispense the supply water from the second receptacle 134 to a cup 148 or the like. In addition, referring back to FIG. 1, the second receptacle 134 may include an inlet port 150. In some instances, the inlet port 150 may be disposed away from the handle 136 side of the second receptacle 134 to stabilize the second receptacle 134 when docked on the support base 102.

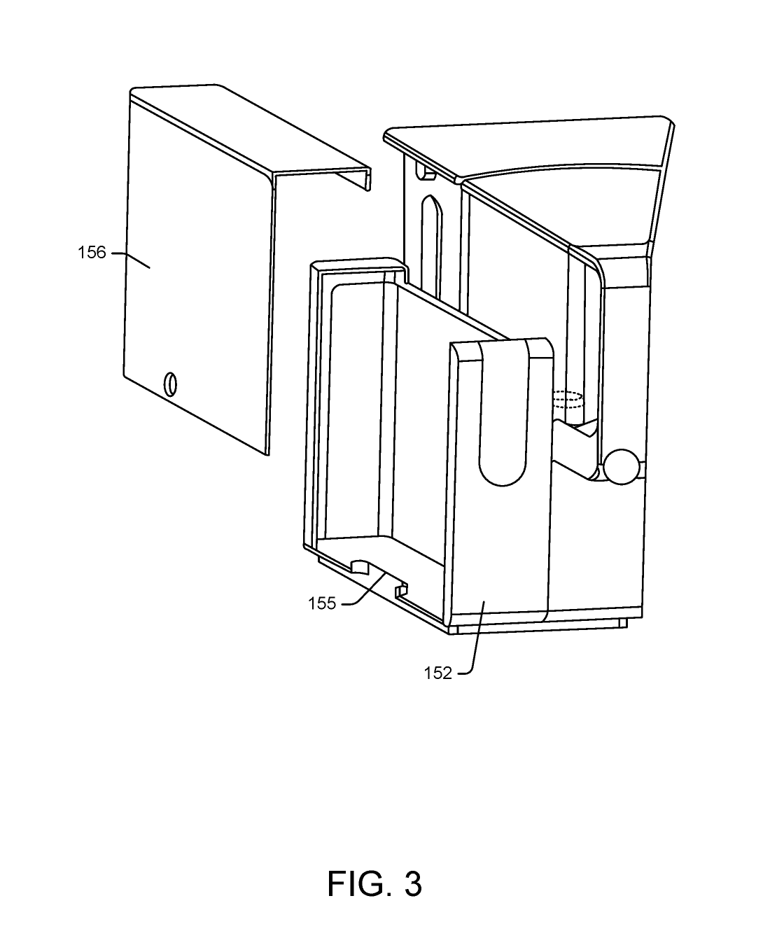

As depicted in FIG. 3, the support base 102 may include a filter compartment 152. At least a portion of a filter system 154 may be disposed between the first receptacle 104 and the second receptacle 134 within the filter compartment 152. The filter compartment 152 may include a removable panel 156 for accessing the filter system 154. In some instances, the filter compartment 152 may include a cutout portion 155 for removing the panel 156.

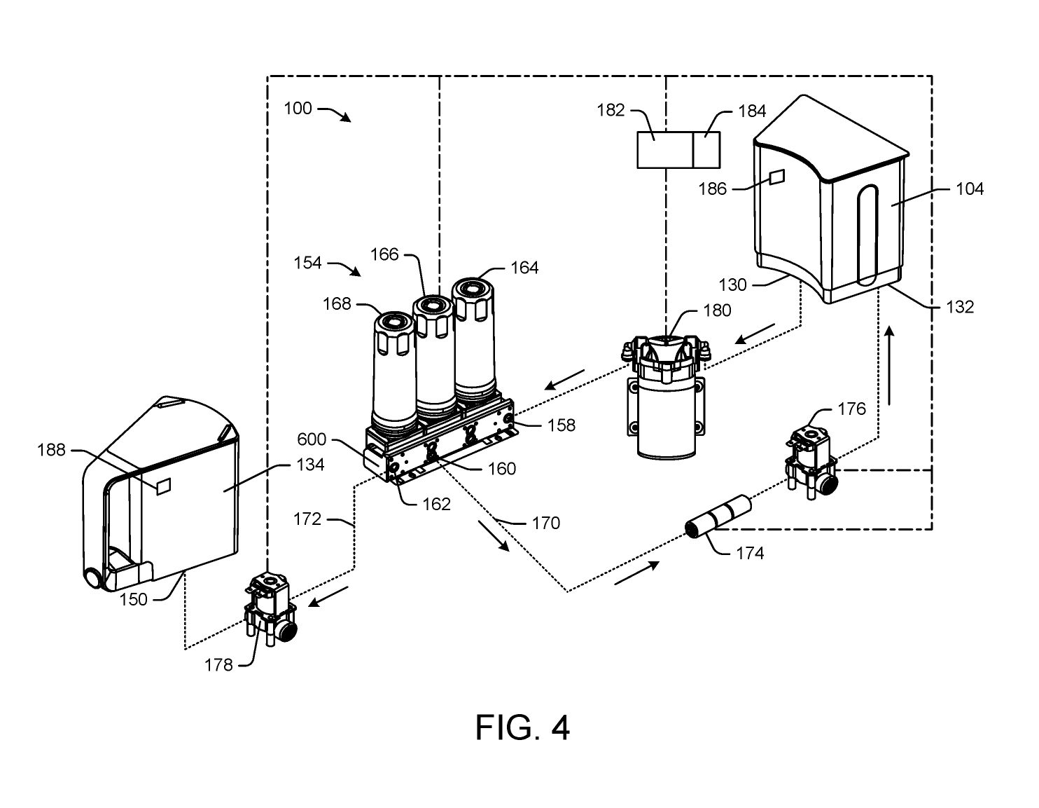

As depicted in FIG. 4, the filter system 154 may include an inlet port 158, a first outlet port 160, and a second outlet port 162. In some instances, when the first receptacle 104 and the second receptacle 134 are attached to the support base 102, the outlet port 130 of the first receptacle 104 may be disposed in fluid communication with the inlet port 158 of the filter system 154. Moreover, the first outlet port 160 of the filter system 154 may be disposed in fluid communication with the inlet port 132 of the first receptacle 104. In addition, the second outlet port 162 of the filter system 154 may be disposed in fluid communication with the inlet port 150 of the second receptacle 134.

In certain embodiments, the filter system 154 may include a first filter 164, a second filter 166, and a third filter 168. Additional or fewer filters may be used. The first filter 164 may be configured and disposed to receive water from the inlet port 158 of the filter system 154 and to filter and deliver first filtered water to the second filter 166. In some instances, the first filter 164 may be a sediment filter or a combination of a sediment filter and a carbon filter. The first filter 164 may comprise any suitable filter. In some instances, additional filters may be disposed upstream of the first filter 164.

The second filter 166 may be configured and disposed to receive the first filtered water from the first filter 164 and to deliver a first portion of the first filtered water to the first outlet port 160 of the filter system 154. In this manner, the first portion of the first filtered water may comprise waste water 170 that is delivered back to the first receptacle 104. Moreover, the second filter 166 may be configured to filter and deliver a second portion of the first filtered water to the third filter 168. The second portion of the first filtered water may comprise second filtered water. In some instances, the second filter 166 may be a reverse osmosis membrane type filter. The second filter 166 may be any suitable filter.

The third filter 168 may be configured and disposed to receive the second filtered water from the second filter 166 and to filter and deliver third filtered water to the second outlet port 162 of the filter system 154. In this manner, the third filtered water may comprise the supply water 172 that is delivered to the second receptacle 134. In some instances, the third filter 168 may be a carbon filter. The third filter 168 may be any suitable filter. In other instances, the third filter 168 may be omitted. In such instances, the second filter 166 may be configured to filter and deliver the second portion of the first filtered water to the second receptacle 134. In yet other instances, additional filters may be disposed downstream of the third filter 168 before the second receptacle 134.

In certain embodiments, about 100% of the water that enters the first filter 164 may pass to the second filter 166. In another embodiment, less than 100% of the water that enters the second filter 166 may pass to the third filter 168. For example, about 1% to about 30% of the water that enters the second filter 166 may pass to the third filter 168, with the remaining water constituting the waste water 170 that is delivered back to the first receptacle 104. In yet another embodiment, about 100% of the water that enters the third filter 168 may pass to the second receptacle 134. This process is repeated as needed.

The water filtration system 100 may include a flow restrictor 174. The flow restrictor 174 may be disposed between and in fluid communication with the first outlet port 160 of the filter system 154 and the inlet port 132 of the first receptacle 104. The flow restrictor 174 may be configured to create a back pressure in the second filter 166 (e.g., on the reverse osmosis membrane). The back pressure may enable the second portion of the first filtered water to pass through the reverse osmosis membrane to produce the second filtered water. Moreover, a return check valve 176 may be disposed between and in fluid communication with the flow restrictor 174 and the inlet port 132 of the first receptacle 104. The return check valve 176 may be configured to prevent water flow from the first receptacle 104 to the filter system 154.

In certain embodiments, a forward check valve 178 may be disposed between and in fluid communication with the second outlet port 162 of the filter system 154 and the inlet port 150 of the second receptacle 134. The forward check valve 178 may be configured to prevent water flow from the second receptacle 134 to the filter system 154.

The water filtration system 100 may include a pump 180 disposed between and in fluid communication with the outlet port 130 of the first receptacle 104 and the inlet port 158 of the filter system 154. In some instances, the pump 180 may be automatically primed by the fluid flow from the outlet port 130 of the first receptacle 104. For example, the water supplied to the pump 180 may be gravity fed from the outlet port 130 of the first receptacle 104. The pump 180 may be the sole source for generating hydraulic pressure that facilitates fluid flow from the first receptacle 104 through the filter system 154 to the second receptacle 134. In some instances, the pump 180 may facilitate fluid flow from the first receptacle 104 through only a portion of the filter system 154 and back to the first receptacle 104 via the flow restrictor 174.

In certain embodiment, the water filtration system 100 may include a supply of electrical power 182, an electronic controller 184, a first sensor 186 disposed and configured to sense a water level in the first receptacle 104, and a second sensor 188 disposed and configured to sense a water level in the second receptacle 134. The electronic controller 184 may be disposed in signal communication with the supply of electrical power 182, the first sensor 186, the second sensor 188, and the pump 180. In some instances, the electrical controller 184 may be configured to sense, via the first sensor 186, a water level in the first receptacle 104 sufficient enough to enable activation of the pump 180. The electrical controller 184 also may be configured to sense, via the second sensor 188, a water level in the second receptacle 134 deficient enough to enable activation of the pump 180. Moreover, the electrical controller 184 may be configured to activate or deactivate the pump 180 in accordance with the respective water levels in the first receptacle 104 and the second receptacle 134. In other instances, the electric power 182 and/or the electrical controller 184 may be in communication with one or more of the filter system 154, the flow restrictor 174, the return check valve 176, and/or the forward check valve 178.

The supply of electrical power 182 may include an electrical cord connectable to an alternating current (AC) line voltage. In some instances, the AC line voltage may be 120 VAC. In other instances, the supply of electrical power 182 may include at least one direct current (DC) battery. The at least one DC battery may be configured to provide 12 VDC or 24 VDC. The supply of electrical power 182 may include an electrical input port configured to receive a DC voltage.

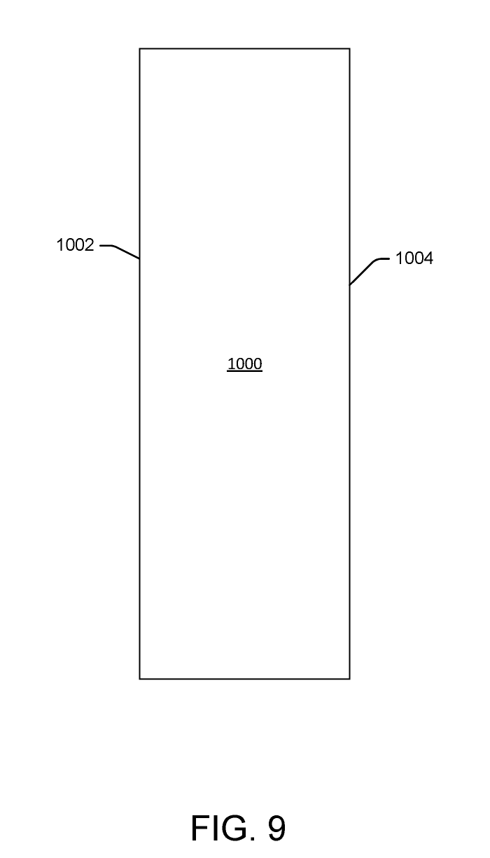

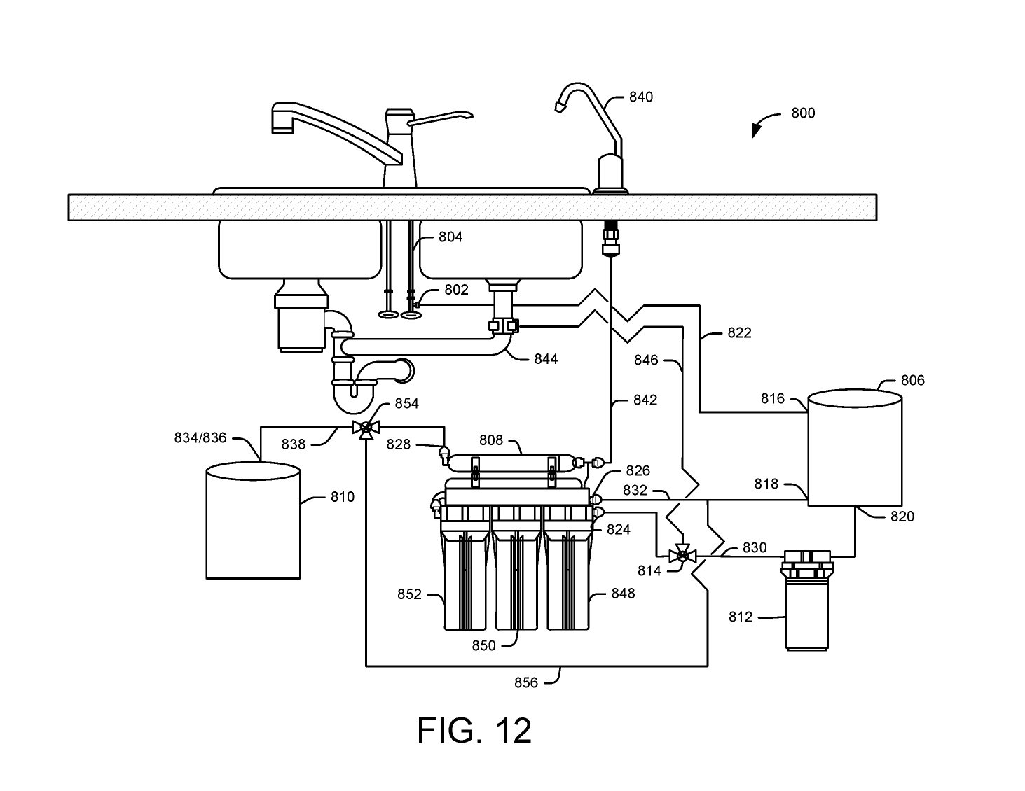

As noted above, the second filter 166 may be a RO membrane type filter. In this manner, the second filter 166 may include an RO membrane therein. Any of the filters discussed above may be an RO membrane type filter. FIG. 9 depicts an example RO membrane 1000 that may be used herein. The RO membrane 1000 may include a clean side 1002 and a brine side 1004. The clean side 1002 of the RO membrane 1000 may face the second receptacle 134, and the brine side 1004 of the RO membrane 1000 may face the first receptacle 104. In some instances, when the second receptacle 134 is full of clean water, the water filtration system 100 will shut down or idle by deactivating the pump 180. In such instances, the contaminants removed by the RO membrane 1000, in the absence of pressure from the pump 180, start migrating into the clean side 1002 of the RO membrane 1000 through regular osmosis (as opposed to pressure induced reverse osmosis). This is known as membrane creep. As a result, each time the pump 180 is activated and the water filtration system 100 turns back on to refill the second receptacle 134 with clean water, an initial dose of high TDS water is added to the second receptacle 134 (i.e., clean water tank). Membrane creep similarly happens in the RO membranes in the POE embodiments discussed in FIGS. 12-14 below.

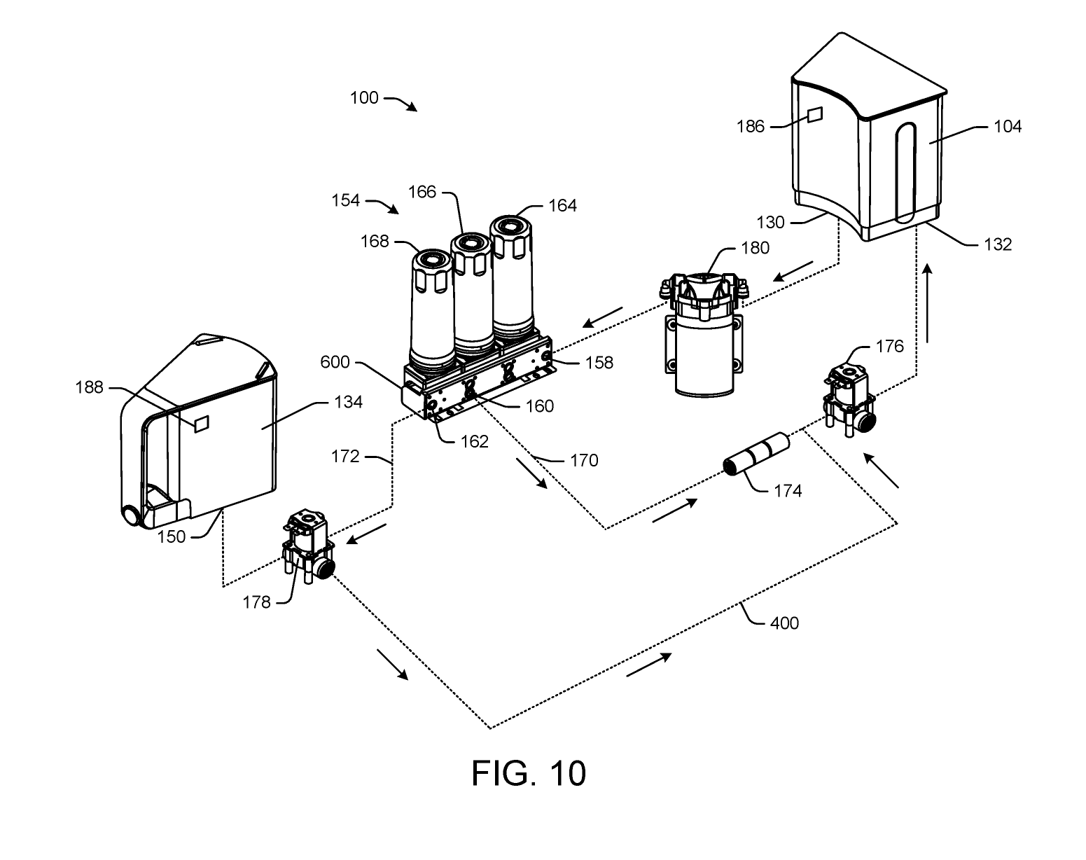

As depicted in FIG. 10, to address membrane creep, when water is removed from the second receptacle 134 and the pump 180 is activated to produce clean water to refill the second receptacle 134, the forward check valve 178 (which may also be a solenoid valve or the like) may be closed or reconfigured so that clean water is initially directed to a bypass line 400 to the low pressure side of the flow restrictor 174. This will take the initial high salt content clean water and reroute it back into the first receptacle 104. After a predetermined amount of time (e.g., 2 minutes, although any suitable amount of time may be used) the forward check valve 178 may be opened to the second receptacle 134 and closed to the bypass line 400 thereby providing the filtered water to the second receptacle 134. In this manner, all the effluent water leaving the RO membrane for an initial period of time is diverted back into the source/tap water tank in order to “clean out” or “flush” the RO filter before the filtered water is provided to the clean water tank. By initially using the bypass line 400 for a predetermined about of time, the impact of the membrane creep can by eliminated or reduced. With the flush feature, the cleaned water is initially diverted back to the tap water tank instead of filling the clean water tank. This removes water with high salt content from the filters before it blends with the purified water. The high salt content is from salt that migrates from the brine on the dirty side of the membrane to the clean side of the membrane when the unit is not in use.

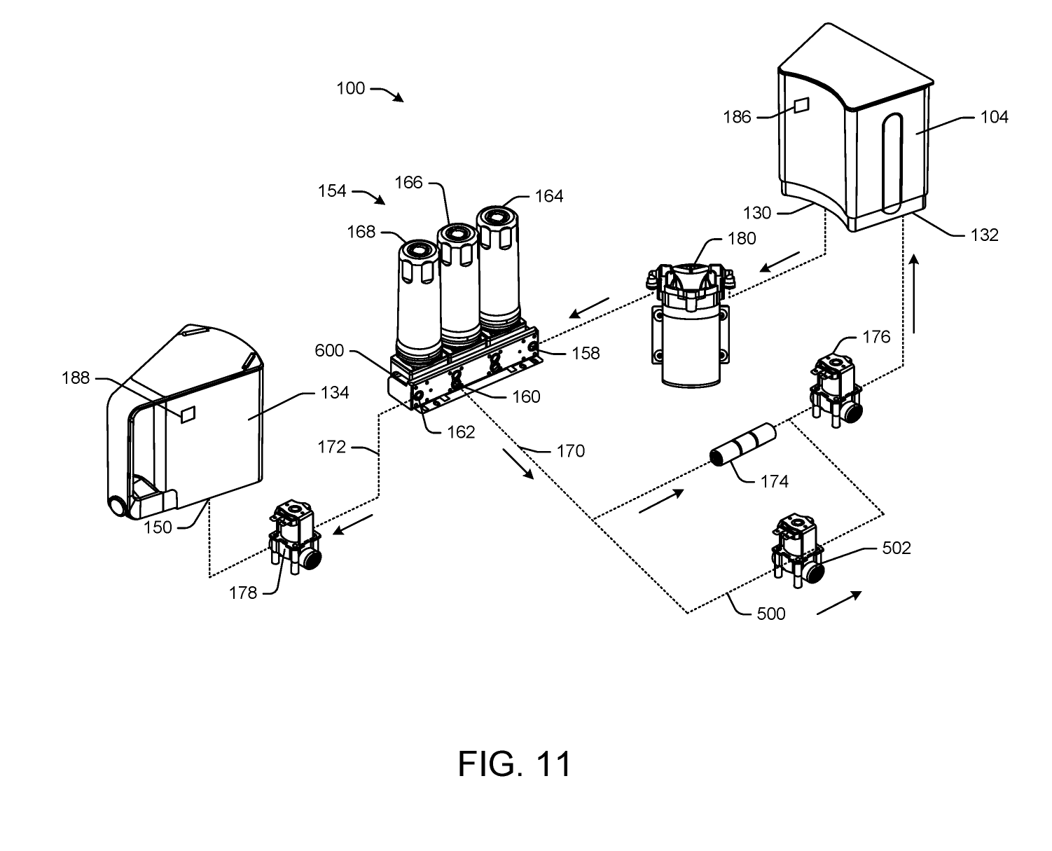

FIG. 11 depicts another example bypass system. In this instance, the flow restrictor 174 is bypassed via bypass line 500. A valve 502 (such as a solenoid valve or the like) disposed on the bypass line may be opened and closed to open and close the bypass line 500. The flow restrictor 174 determines the ratio of waste water to clean water. That is, the flow restrictor 174 determines the ratio of the first portion of the first filtered water that comprises waste water 170 and second portion of the first filtered water that comprises the supply water 172 that is delivered to the second receptacle 134. When the valve 502 is open, the flow restrictor 174 is bypassed via bypass line 500. As a result, 100% of the water exiting the second filter will flow to the first receptacle 104 (i.e., the waste/tap water tank).

In another embodiment, in order to eliminate or reduce membrane creep, after the pump 180 has completed a cycle to produce clean water and has been deactivated, the forward check valve 178 (which may be a solenoid valve) may be closed to prevent water from entering the second receptacle 134, which may be full with clean water. The return check valve 176 (which may be a solenoid valve) may be opened. This configuration allows water from the feed water side (or brine side) of the membrane to flow back into the first receptacle 104. Pressure on the feed side of the membrane will drop to just a few PSI (depending on the height of water in the first receptacle 104). As a result, RO flow will stop. Just after this, there is an osmotic potential that drives pure water from clean side of the membrane (as long as the valve 176 is open) to the feed side of the membrane. The backflow through the membrane is not driven by the pressure differential (permeate to feed), but by the salinity differential.

In another embodiment, in order to eliminate or reduce membrane creep, the filters may be inverted. For example, as depicted in FIG. 4, the inlets and outlets may be located in a filter base 600. The filters 164, 166, and 168 may be attached to a top portion of the filter base 600 in an inverted configuration. Any number of filters may be attached to the filter base 600. In this manner, the inlet port 158, the first outlet port 160, and the second outlet port 162 may be disposed in the filter base 600 below the RO membrane 1000. The inverted filters may allow water to flow back from the filters to the first receptacle 104 when the pump 180 is deactivated. As a result, pressure may be reduced about the RO membrane 1000, which may reduce membrane creep. The inverted filters may be used in conjunction with any of the embodiments disclosed herein, including those depicted in FIGS. 12-14.

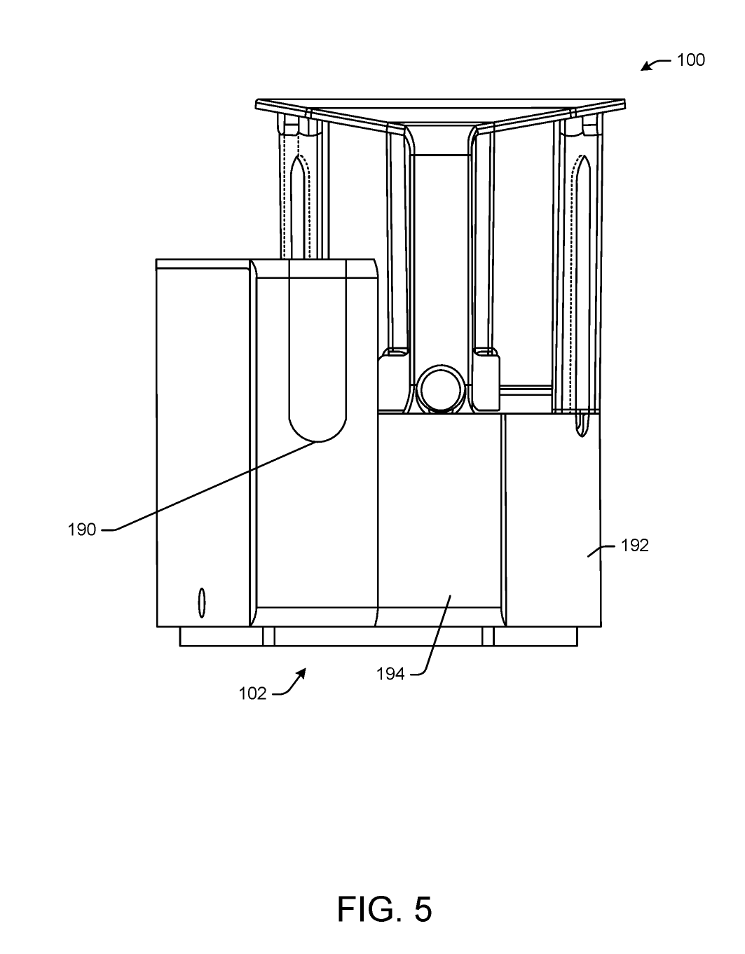

In certain embodiments, as depicted in FIG. 5, the water filtration system 100 may include a control panel 190. In some instances, the control panel 190 may be disposed on the support base 102. The control panel 190 may include one or more user accessible buttons for controlling the water filtration system 100. For example, the control panel 190 may enable a user to turn the water filtration system 100 on or off. Moreover, the control panel 190 may include one or more indicators configured to provide the user with an indication of the status of the water filtration system 100. For example, the indicators may denote that the water filtration system 100 is actively filtering water, that the second receptacle 134 is full, that the first receptacle 104 is empty, and/or that the filter system 154 (e.g., the first filter 164, the second filter 166, and/or the third filter 168) should be replaced or cleaned, etc.

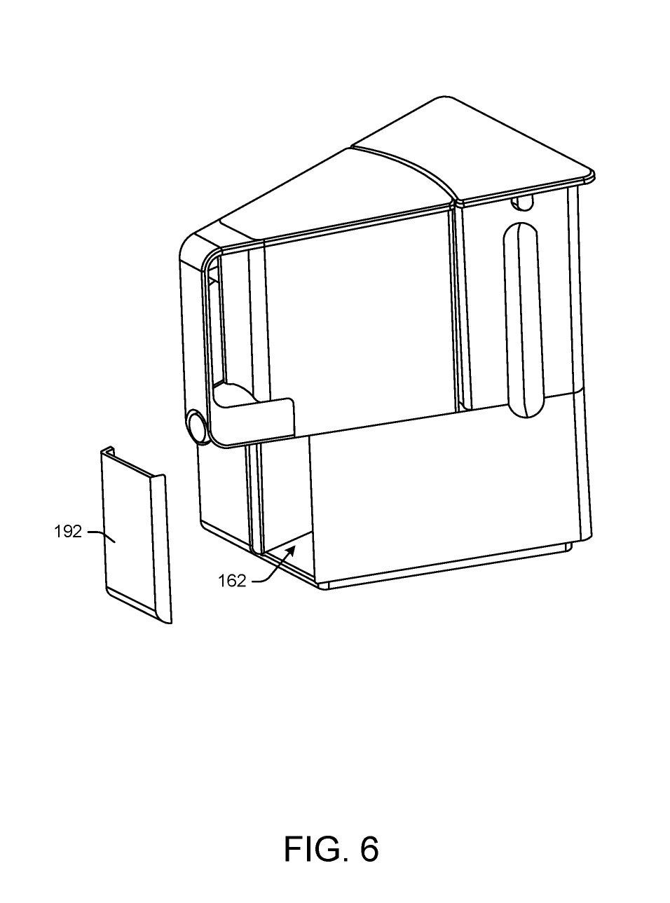

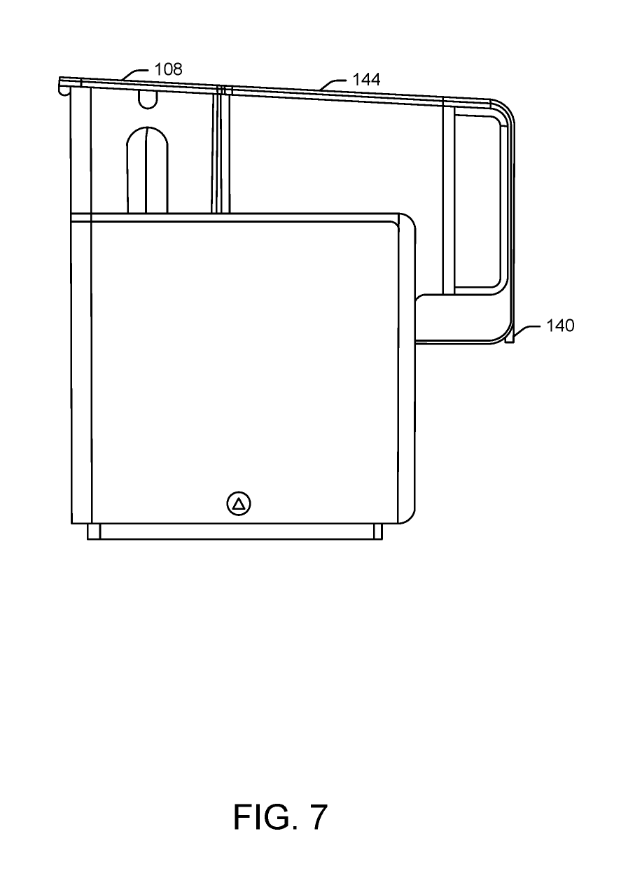

In some instances, as depicted in FIGS. 5 and 6, the support base 102 may include a utility compartment 192 configured to house at least a portion of the filter system 154, the flow restrictor 174, the return check valve 176, the forward check valve 178, and/or the pump 180. The utility compartment 192 may include a removable panel 194 for accessing one or more of the various components of the water filtration system 100. In certain embodiments, as depicted in FIG. 7, the openable lid 108 and the removable lid 144 may be angled downward towards the dispense actuator 140.

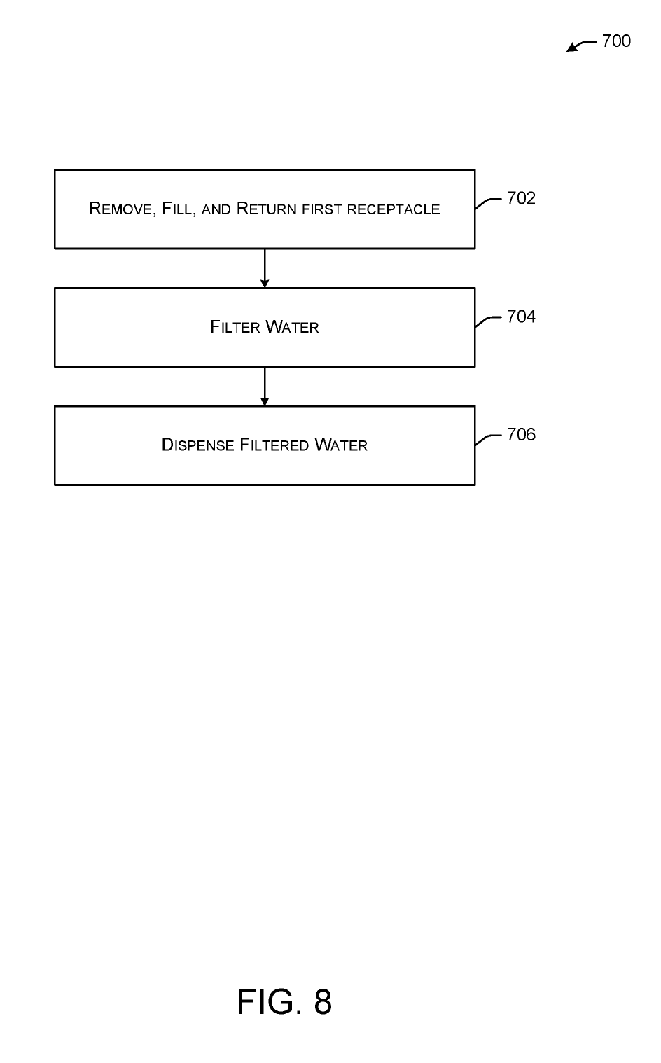

FIG. 8 is a flow diagram depicting an illustrative method 700 for filtering water with the water filtration system 100 in accordance with one or more embodiments of the disclosure.

At block 702 of method 700, the first receptacle 104 may be removed from the support base 102, filled with water, and returned back to the support base 102. For example, a user may pour water (e.g. tap water) into the first receptacle 104, or a user may remove the first receptacle 104 from the support base 102 and fill it with water (e.g., tap water). The user may open the openable lid 108 and pour water into the fill opening 106. In some instances, a user may engage the lip 112 to open and close the openable lid 108.

Upon returning the first receptacle filled with water back to the support base at block 702, the water may be filtered by the filter system at block 704. That is, when the first receptacle 104 and the second receptacle 134 are attached to the support base 102, the outlet port 130 of the first receptacle 104 may be disposed in fluid communication with the inlet port 158 of the filter system 154. Moreover, the first outlet port 160 of the filter system 154 may be disposed in fluid communication with the inlet port 132 of the first receptacle 104. In addition, the second outlet port 162 of the filter system 154 may be disposed in fluid communication with the inlet port 150 of the second receptacle 134.

The first filter 164 may be configured and disposed to receive water from the inlet port 158 of the filter system 154 and to filter and deliver first filtered water to the second filter 166. In some instances, the first filter 164 may be a sediment filter or a combination of a sediment filter and a carbon filter. The first filter 164 may comprise any suitable filter.

The second filter 166 may be configured and disposed to receive the first filtered water from the first filter 164 and to deliver a first portion of the first filtered water to the first outlet port 160 of the filter system 154. In this manner, the first portion of the first filtered water may comprise waste water 170 that is delivered back to the first receptacle 104. Moreover, the second filter 166 may be configured to filter and deliver a second portion of the first filtered water to the third filter 168. The second portion of the first filtered water may comprise second filtered water. In some instances, the second filter 166 may be a reverse osmosis membrane type filter. The second filter 166 may be any suitable filter.

The third filter 168 may be configured and disposed to receive the second filtered water from the second filter 166 and to filter and deliver third filtered water to the second outlet port 162 of the filter system 154. In this manner, the third filtered water may comprise the supply water 172 that is delivered to the second receptacle 134. In some instances, the third filter 168 may be a carbon filter. The third filter 168 may be any suitable filter.

At block 706 of method 700, the filtered water may be dispensed from the second receptacle. For example, the second receptacle 134 may be configured to store supply water (e.g., filtered drinking water) therein. A user may dispense the supply water from the second receptacle 134 by manipulating the dispense actuator 140. In other instances, a user may dispense the supply water from the opening 142 disposed about the lid 144 of the second receptacle 134. For example, a user may dispense the supply water from the second receptacle 134 to a cup 148 or the like.

In certain embodiments, the steps described in blocks 702-706 of method 700 may be performed in any order. The steps described in blocks 702-706 of method 700 are but one example of several embodiments. For example, certain steps may be omitted, while other steps may be added.

### Point-of-Entry Water Treatment Devices, Systems, and Methods

FIGS. 12-14 depict an under the sink RO water filtration system that is plumed into a building's water supply. For example, the water filtration systems may include an RO device at least partially installed underneath a sink, with the tap water connection plumbed directly to the sink cold water supply line, and a waste water drain line connected directly to the sink drain, such as the p-trap. The water filtration systems may use a membrane to screen out chemicals, such as chloride and sulfate as well as most other contaminates found in the water supply. The water filtration systems may be used to filter any contaminates. In this manner, the water filtration systems may provide the technical advantage and/or solution of providing filtered water. Moreover, the water filtration systems may provide the technical advantage and/or solution of little to no waste water and/or limit or reduce membrane creep. These and other technical advantages and/or solutions will become apparent throughout the disclosure.

In one embodiment, as depicted in FIG. 12, the water filtration system may include a reverse osmosis water treatment system 800. The system 800 may include a source of water 802, such as tap water from a sink's cold water supply line 804. Any source of water 802 may be used herein. The system 800 also may include a water tank 806, a filter system 808, a filtered water tank 810, a pump 812, and a valve 814. The water tank 806 may include a first inlet 816, a second inlet 818, and an outlet 820. The first inlet 816 of the water tank 806 may be in fluid communication with the source of water 802 by way of a pipe 822. In this manner, the water tank 806 may store water therein.

The filter system 808 may comprise an inlet 824, a first outlet 826, and a second outlet 828. The inlet 824 of the filtration system 808 may be in fluid communication with the outlet 820 of the water tank 806 by way of a pipe 830. Also, the first outlet 826 of the filter system 808 may be in fluid communication with the second inlet 818 of the water tank 806 by way of a pipe 832. In this manner, the first outlet 826 of the filter system 808 may supply waste water from the filter system 808 to the water tank 806. As a result, the water tank 806 may include a mixture of water from the source of water 802 and waste water from the filter system 808.

The filtered water tank 810 may include an inlet 834 and an outlet 836. In some instances, the inlet 834 and the outlet 836 of the filtered water tank 810 may be one in the same, such as a two-way valve or the like. In other instances, the inlet 834 and the outlet 836 of the filtered water tank 810 may be separate components. The inlet 834 of the filtered water 810 tank may be in fluid communication with the second outlet 828 of the filter system 808 by way of a pipe 838. In this manner, the second outlet 828 of the filter system 808 may supply filtered water to the filtered water tank 810. In addition, the outlet 836 of the filtered water tank 810 may be in fluid communication with a faucet 840 by way of a pipe 842. In this manner, the outlet 836 of the filtered water tank 810 may supply the filtered water to the faucet 840.

The pump 812 may be disposed in fluid communication between the water tank 806 and the filter system 808 along the pipe 830. In addition, the valve 814 may be disposed in fluid communication between the pump 812 and the filter system 808 along the pipe 830. The valve 814 also may be in fluid communication with a drain 844 by way of a drain pipe 846. In some instances, the valve 814 may be a three-way valve or the like. The valve 814 may divert a first portion of water from the water tank 806 to the filter system by way of the pipe 830. In some instances, the first portion of water may comprise about 95% of the water that enters the valve 814. Moreover, the valve 814 may divert a second portion of water from the water tank 806 to the drain 844 by way of the drain pipe 846. In some instances, the second portion of water may comprise about 5% of the water that enters the valve 814. Any percentage of water may be supplied to the filter system 808 or diverted to the drain 844. In a preferred embodiment, the majority of the water in the system 800 is filtered, with a minimal amount of water being disposed of via the drain 844.

In some instances, the filter system 808 may comprise a first filter 848, a second filter 850, and a third filter 852. The first filter 848 may be configured to receive water from the inlet 824 of the filter system 808. The first filter 848 may filter the water and deliver a first filtered water to the second filter 850. The second filter 850 may be configured to receive the first filtered water from the first filter 848. The second filter 850 may bifurcate the first filtered water into a first portion and a second portion. The second filter 850 may be a reverse osmosis filter or the like. The first portion of the first filtered water may be supplied to the first outlet 826 of the filter system 808. In this manner, the first portion of the first filtered water may comprise the waste water that is delivered back to the water tank 806 via pipe 832. The second portion of the first filtered water may be supplied to the third filter 852. The third filter 852 may be configured to receive the filtered water from the second filter 850, to further filter the water, and to deliver the filtered water to the second outlet 828 of the filter system 808. In this manner, the second portion of the first filtered water, which is collectively filtered by the first filter 848, the second filter 850, and the third filter 852, comprises the filtered water that is supplied the filtered water tank 810 via pipe 838.

In certain embodiment, the first filter 848 may comprise a sediment filter, a carbon filter, a KDF filter, or a combination thereof. The second filter 850 may comprise a reverse osmosis membrane. The third filter 852 may comprises a carbon filter, an ion exchange filter, a remineralization element, or a combination thereof. In other instances, the third filter 852 may be omitted. In such instances, the second filter 850 may be configured to filter and deliver the second portion of the first filtered water to the filtered water tank 810. In yet other instances, additional filters may be disposed downstream of the third filter 850 before the filtered water tank 810. Any number, type, and/or combination of filters may be used herein.

In certain embodiments, 100% of the water that enters the first filter 848 may pass to the second filter 850. In other instances, less than 100% of the water that enters the second filter 850 passes to the third filter 852. For example, about 1% to about 30% of the water that enters the second filter 850 may pass to the third filter 852, with the remaining water constituting the waste water that is delivered back to the water tank 806 via pipe 832. In yet another embodiment, 100% of the water that enters the third filter 852 may pass to the filtered water tank 810 via pipe 838. Any percentage of water may enter the first filter 848, the second filter 850, or the third filter 852.

In operation, water is supplied to the water tank 806 from the water source 802 via pipe 822. The water source 802 may continually feed the water tank 806 as needed, leaving at least some space within the water tank 806 for waste water from the filter system 808. In some instances, a valve may be disposed along pipe 822 to control the flow of fluid to the water tank 806. The pump 812 may pump the mixture of source water and waste water from the water tank 806 into the valve 814. The valve 814 may then bifurcate a small portion of the water into the drain 844 and a majority of the water into the filtration system 808. In this manner, most of the water is filtered and supplied to the filtered water tank 810 to be dispensed by the faucet 840. A small portion of the waste water is recycled back to the water tank 806 by way of the pipe 832 to be mixed with the source water and the cycle continued.

The system 800 may include additional components and functionality. For example, the system 800 may include a UV treatment device, a heater, a chiller, and/or a carbonator. In addition, the system 800 may include devices capable of adding vitamins to the water and/or re-mineralizing the water. In certain embodiments, the system 800 may include a supply of electrical power, an electronic controller, and one or more sensors to monitor and control the dispensing of filtered water.

To address membrane creep, when water is removed from the filtered water tank 810 and the pump 812 is activated to produce clean water to refill the filtered water tank 810, a valve 854 (which may also be a solenoid valve or the like) may be closed or reconfigured so that filtered water is initially directed to a bypass line 856 that directs the filtered water back to the water tank 806. For example, the bypass line 856 may connect the pipe 838 to the pipe 832 such that water exiting the filter system 808 via the second outlet 828 is directed back to the water tank 806. This will take the initial high salt content clean water and reroute it back into the water tank 806. After a predetermined amount of time (e.g., 2 minutes, although any suitable amount of time may be used) the valve 854 may be opened to the filtered water tank 810 and closed to the bypass line 856 thereby providing the filtered water to the filtered water tank 810. In this manner, all the effluent water leaving the RO membrane for an initial period of time is diverted back into the source/tap water tank 806 in order to “clean out” or “flush” the RO filter before the filtered water is provided to the filtered water tank 810. By initially using the bypass line 856 for a predetermined about of time, the impact of the membrane creep can by eliminated or reduced. With the flush feature, the cleaned water is initially diverted back to the tap water tank 806 instead of filling the filtered water tank 810. This removes water with high salt content from the filters before it blends with the purified water. The high salt content is from salt that migrates from the brine on the dirty side of the membrane to the clean side of the membrane when the unit is not in use. In an alternate configuration, the bypass line 856 may connect the pipe 838 and the water tank 806 directly. The bypass line 856 also may connect the pipe 838 to the drain 844 and/or drain pipe 846.

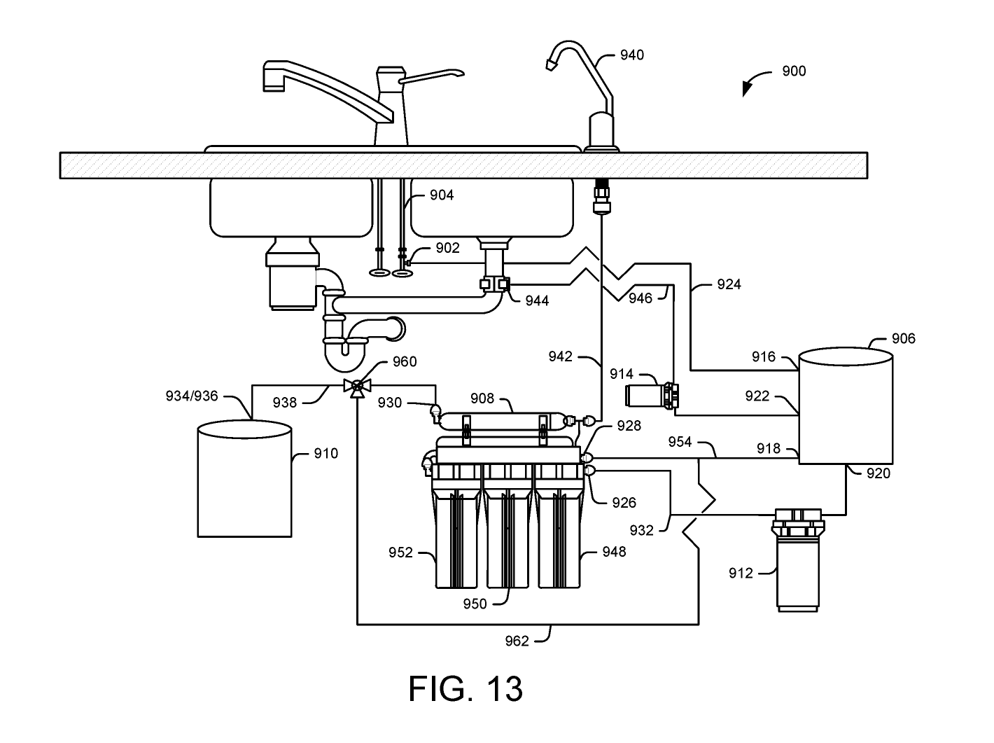

FIG. 13 depicts an additional embodiment of a water filtration system comprising a reverse osmosis water treatment system 900. The system 900 may include a source of water 902, such as tap water from a sink's cold water supply line 904. Any source of water 902 may be used herein. The system 900 also may include a water tank 906, a filter system 908, a filtered water tank 910, a first pump 912, and a second pump 914. The water tank 906 may include a first inlet 916, a second inlet 918, a first outlet 920, and a second outlet 922. The first inlet 916 of the water tank 906 may be in fluid communication with the source of water 902 by way of a pipe 924.

The filter system 908 may include an inlet 926, a first outlet 928, and a second outlet 930. The inlet 926 of the filtration system 908 may be in fluid communication with the first outlet 920 of the water tank 906 bay way of a pipe 932. In addition, the first outlet 928 of the filter system 908 may be in fluid communication with the second inlet 918 of the water tank 906 by way of a pipe 954. In this manner, the first outlet 928 of the filter system 908 may supply waste water to the water tank 906 via pipe 954. As a result, the water tank 906 may comprise a mixture of water from the source of water 902 and waste water from the filter system 908.

The filtered water tank 910 may include an inlet 934 and an outlet 936. In some instances, the inlet 934 and the outlet 936 of the filtered water tank 910 may be one in the same, such as a two-way valve or the like. In other instances, the inlet 934 and the outlet 936 of the filtered water tank 910 may be separate components. The inlet 934 of the filtered water 910 tank may be in fluid communication with the second outlet 930 of the filter system 908 by way of a pipe 938. In this manner, the second outlet 930 of the filter system 908 may supply filtered water to the filtered water tank 910 via pipe 938. In addition, the outlet 936 of the filtered water tank 910 may be in fluid communication with a faucet 940 by way of a pipe 942. In this manner, the outlet 936 of the filtered water tank 910 may supply the filtered water to the faucet 940 via pipe 942.

The first pump 912 may be disposed in fluid communication between the water tank 906 and the filter system 908 along the pipe 932. The first pump 912 may facilitate flow between the water tank 906 and the filter system 908. The second pump 914 may be disposed in fluid communication between the water tank 906 and a drain 944. For example, the second outlet 922 of the water tank 906 may be in fluid communication with the second pump 914. The second pump 914 may be configured to supply a portion of the water from the water tank 906 to the drain 944 by way of a drain pipe 946.

In some instances, the filter system 908 may comprise a first filter 948, a second filter 950, and a third filter 952. The first filter 948 may be configured to receive water from the inlet 926 of the filter system 908. The first filter 948 may filter the water and deliver a first filtered water to the second filter 950. The second filter 950 may be configured to receive the first filtered water from the first filter 948. The second filter 950 may bifurcate the first filtered water into a first portion and a second portion. The second filter 950 may comprise a reverse osmosis filter or the like. The first portion of the first filtered water may be supplied to the first outlet 928 of the filter system 108. In this manner, the first portion of the first filtered water may comprise the waste water that is delivered back to the water tank 906 by way of the pipe 954. The second portion of the first filtered water may be supplied to the third filter 952. The third filter 952 may be configured to receive the filtered water from the second filter 950, to further filter the water, and to deliver the filtered water to the second outlet 930 of the filter system 908. In this manner, the second portion of the first filtered water, which is collectively filtered by the first filter 948, the second filter 950, and the third filter 952, comprises the filtered water that is supplied the filtered water tank 910 by way of the pipe 938.

In certain embodiment, the first filter 948 may comprise a sediment filter, a carbon filter, a KDF filter, or a combination thereof. The second filter 950 may comprise a reverse osmosis membrane. The third filter 950 may comprises a carbon filter, an ion exchange filter, a remineralization element, or a combination thereof. In other instances, the third filter 952 may be omitted. In such instances, the second filter 950 may be configured to filter and deliver the second portion of the first filtered water to the filtered water tank 910. In yet other instances, additional filters may be disposed downstream of the third filter 950 before the filtered water tank 910. Any number, type, and/or combination of filters may be used herein.

In certain embodiments, 100% of the water that enters the first filter 948 may pass to the second filter 950. In other instances, less than 100% of the water that enters the second filter 950 passes to the third filter 952. For example, about 1% to about 30% of the water that enters the second filter 950 may pass to the third filter 952, with the remaining water constituting the waste water that is delivered back to the water tank 906 via the pipe 954. In yet another embodiment, 100% of the water that enters the third filter 952 may pass to the filtered water tank 910 via the pipe 938. Any percentage of water may enter the first filter 948, the second filter 950, or the third filter 952.

In operation, water is supplied to the water tank 906 from the water source 902 via the pipe 924. The water source 902 may continually feed the water tank 906 as needed, leaving at least some space within the water tank 906 for waste water from the filter system 908. In some instances, a valve may be disposed along pipe 924 to control the flow of water to the water tank 906. The first pump 912 may pump the mixture of source water and waste water from the water tank 906 to the filter system 908. As discussed above, the filter system 908 may filter a portion of the water, which may be supplied to the filtered water tank 910 to be dispensed by the faucet 940. All of the waste water from the filter system 908 may be recycled back to the water tank 906 via the pipe 954 to be mixed with the source water and the cycle continued. The second pump 914 may empty a portion of the water from the water tank 906 to the drain 944 via the pipe 946.

The system 900 may include additional components and functionality. For example, the system 900 may include a UV treatment device, a heater, a chiller, and/or a carbonator. In addition, the system 900 may include devices capable of adding vitamins to the water and/or re-mineralizing the water. In certain embodiments, the system 900 may include a supply of electrical power, an electronic controller, and one or more sensors to monitor and control the dispensing of filtered water.

To address membrane creep, when water is removed from the filtered water tank 910 and the pump 912 is activated to produce clean water to refill the filtered water tank 910, a valve 960 (which may also be a solenoid valve or the like) may be closed or reconfigured so that filtered water is initially directed to a bypass line 962 that directs the filtered water back to the water tank 906. For example, the bypass line 962 may connect the pipe 938 to the pipe 954 such that water exiting the filter system 908 via the second outlet 930 is directed back to the water tank 906. This will take the initial high salt content clean water and reroute it back into the water tank 906. After a predetermined amount of time (e.g., 2 minutes, although any suitable amount of time may be used) the valve 960 may be opened to the filtered water tank 910 and closed to the bypass line 962 thereby providing the filtered water to the filtered water tank 910. In this manner, all the effluent water leaving the RO membrane for an initial period of time is diverted back into the source/tap water tank 906 in order to “clean out” or “flush” the RO filter before the filtered water is provided to the filtered water tank 910. By initially using the bypass line 962 for a predetermined about of time, the impact of the membrane creep can by eliminated or reduced. With the flush feature, the cleaned water is initially diverted back to the tap water tank 906 instead of filling the filtered water tank 910. This removes water with high salt content from the filters before it blends with the purified water. The high salt content is from salt that migrates from the brine on the dirty side of the membrane to the clean side of the membrane when the unit is not in use. In an alternate configuration, the bypass line 962 may connect the pipe 938 and the water tank 906 directly. The bypass line 962 also may connect the pipe 938 to the drain 944 and/or drain pipe 946 downstream of the pump 914.

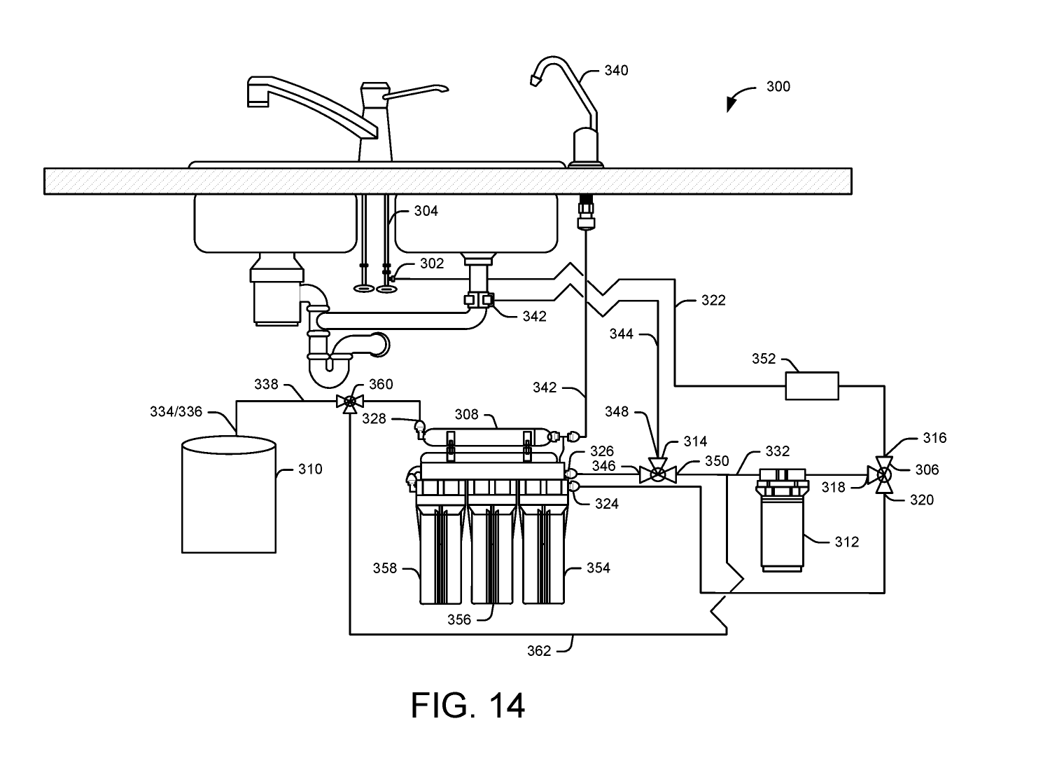

FIG. 14 depicts an additional embodiment of a water filtration system comprising a reverse osmosis water treatment system 300. The system 300 may include a source of water 302, such as tap water from a sink's cold water supply line 304. Any source of water 302 may be used herein. The system 300 also may include a first three-way valve 306, a filter system 308, a filtered water tank 310, a pump 312, and a second three-way valve 314. The first three-way valve 306 may include a first inlet 316, a second inlet 318, and an outlet 320. The first inlet 316 of the first three-way valve 306 may be in fluid communication with the source of water 302 by way of a pipe 322.

The filter system 308 may comprise an inlet 324, a first outlet 326, and a second outlet 328. The inlet 324 of the filtration system 308 may be in fluid communication with the outlet 320 of the first three-way valve 306 by way of a pipe 330. In addition, the first outlet 326 of the filter system 308 may be in fluid communication with the second inlet 318 of the first three-way valve 306 by way of a pipe 332. In this manner, the first outlet 326 of the filter system 308 may supply waste water from the filter system 308 to the first three-way valve 306. The first three-way valve 306 may mix water from the source of water 302 and waste water from the filter system 308. In some instances, the first three-way valve 306 may comprise a water tank or the like.

The filtered water tank 310 may include an inlet 334 and an outlet 336. In some instances, the inlet 334 and the outlet 336 of the filtered water tank 310 may be one in the same, such as a two-way valve or the like. In other instances, the inlet 334 and the outlet 336 of the filtered water tank 310 may be separate components. The inlet 334 of the filtered water 310 tank may be in fluid communication with the second outlet 328 of the filter system 308 by way of a pipe 338. In this manner, the second outlet 328 of the filter system 308 may supply filtered water to the filtered water tank 310 via the pipe 338. In addition, the outlet 336 of the filtered water tank 310 may be in fluid communication with a faucet 340 by way of a pipe 342. In this manner, the outlet 336 of the filtered water tank 310 may supply the filtered water to the faucet 340 via the pipe 342.

The pump 312 may be disposed in fluid communication between the first three-way valve 306 and the filter system 308 along the pipe 332. In addition, the second three-way valve 314 may be disposed in fluid communication between the first three-way valve 306 and the filter system 308 along the pipe 332. The second three-way valve 314 may be in fluid communication with a drain 342 by way of a drain pipe 344. The second three-way valve 314 may include a first inlet 346, a first outlet 348, and a second outlet 350. In this manner, the second three-way valve 314 may divert a first portion of water from the filter system 308 to the first three-way valve 306 by way of the second outlet 350. In some instances, the first portion of water may comprise about 75% of the water that enters the second three-way valve 314. Moreover, the second three-way valve 314 may divert a second portion of water from the filter system 308 to the drain 342 by way of the first outlet 348 and the pipe 344. In some instances, the second portion of water may comprise about 25% of the water that enters the second three-way valve 314. Any percentage of water may be supplied to the first three-way valve 306 or diverted to the drain 342. In this manner, the majority of the water in the system 300 is filtered, with a minimal amount of water being wasted.

In some instances, the system 300 may include a pressure reducer 352 disposed in fluid communication between the source of water 302 and the first three-way valve 306 along the pipe 322. The pressure reducer 352 may provide the source water 302 to the first three-way valve 306 at a suitable pressure, such as 80 PSI. Any pressure may be used herein.

In some instances, the filter system 308 may comprise a first filter 354, a second filter 356, and a third filter 358. The first filter 354 may be configured to receive water from the inlet 324 of the filter system 308. The first filter 354 may filter the water and deliver a first filtered water to the second filter 356. The second filter 356 may be configured to receive the first filtered water from the first filter 354. The second filter 356 may bifurcate the first filtered water into a first portion and a second portion. The second filter 356 may comprise a reverse osmosis filter to the like. The first portion of the first filtered water may be supplied to the first outlet 326 of the filter system 308. In this manner, the first portion of the first filtered water may comprise the waste water that is delivered back to the first three-way valve 306 by way of the pipe 332. The second portion of the first filtered water may be supplied to the third filter 358. The third filter 358 may be configured to receive the filtered water from the second filter 356, to further filter the water, and to deliver the filtered water to the second outlet 328 of the filter system 308. In this manner, the second portion of the first filtered water, which is collectively filtered by the first filter 248, the second filter 250, and the third filter 252, comprises the filtered water that is supplied the filtered water tank 310 by way of the pipe 338.

In certain embodiment, the first filter 354 may comprise a sediment filter, a carbon filter, a KDF filter, or a combination thereof. The second filter 356 may comprise a reverse osmosis membrane. The third filter 358 may comprises a carbon filter, an ion exchange filter, a remineralization element, or a combination thereof. In other instances, the third filter 358 may be omitted. In such instances, the second filter 356 may be configured to filter and deliver the second portion of the first filtered water to the filtered water tank 310. In yet other instances, additional filters may be disposed downstream of the third filter 358 before the filtered water tank 310. Any number, type, and/or combination of filters may be used herein.

In certain embodiments, 100% of the water that enters the first filter 354 may pass to the second filter 356. In other instances, less than 100% of the water that enters the second filter 356 passes to the third filter 358. For example, about 1% to about 30% of the water that enters the second filter 356 may pass to the third filter 358, with the remaining water constituting the waste water that is delivered back to the first three-way-valve 306 by way of the pipe 332. In yet another embodiment, 100% of the water that enters the third filter 358 may pass to the filtered water tank 310. Any percentage of water may enter the first filter 354, the second filter 356, or the third filter 358.

In operation, water is supplied to the first three-way-valve 306 from the water source 302 via the pipe 322. The pressure reducer 352 may provide the water to the first three-way-valve 306 at a suitable pressure. The water source 302 may continually feed the first three-way-valve 306 as needed. Waste water from the filter system 308 may mix with water from the water source 302 in the first three-way-valve 306. For example, as discussed above, the filter system 308 may filter a portion of the water, which may be supplied to the filtered water tank 310 to be dispensed by the faucet 340. A small portion of the waste water from the filter system 308 may be recycled back to the first three-way-valve 306 via the pipe 332 to be mixed with the source water and the cycle continued. The second three-way-valve 314 may divert a portion of the waste water from the filter system 308 to the drain 342 via the drain pipe 344.

The system 300 may include additional components and functionality. For example, the system 300 may include a UV treatment device, a heater, a chiller, and/or a carbonator. In addition, the system 300 may include devices capable of adding vitamins to the water and/or re-mineralizing the water. In certain embodiments, the system 300 may include a supply of electrical power, an electronic controller, and one or more sensors to monitor and control the dispensing of filtered water.

To address membrane creep, when water is removed from the filtered water tank 310 and the pump 312 is activated to produce clean water to refill the filtered water tank 310, a valve 360 (which may also be a solenoid valve or the like) may be closed or reconfigured so that filtered water is initially directed to a bypass line 362 that directs the filtered water back to the pipe 332. For example, the bypass line 362 may connect the pipe 338 to the pipe 332 such that water exiting the filter system 308 via the second outlet 328 is directed back to the inlet 324 of the filter system 308. This will take the initial high salt content clean water and reroute it back into the filter system 308. In this manner, the bypass line 362 may form a filter loop. After a predetermined amount of time (e.g., 2 minutes, although any suitable amount of time may be used) the valve 360 may be opened to the filtered water tank 310 and closed to the bypass line 362 thereby providing the filtered water to the filtered water tank 310. In this manner, all the effluent water leaving the RO membrane for an initial period of time is diverted back into the filter in order to “clean out” or “flush” the RO filter before the filtered water is provided to the filtered water tank 310. By initially using the bypass line 362 for a predetermined about of time, the impact of the membrane creep can by eliminated or reduced. With the flush feature, the cleaned water is initially diverted back to the filter instead of filling the filtered water tank 310. This removes water with high salt content from the filters before it blends with the purified water. The high salt content is from salt that migrates from the brine on the dirty side of the membrane to the clean side of the membrane when the unit is not in use. In an alternate configuration, the bypass line 362 may connect the pipe 338 to the drain 342 and/or drain pipe 344.

In another embodiment, in order to eliminate or reduce membrane creep in the systems depicted in FIGS. 12-14, after the pump has completed a cycle to produce clean water and has been deactivated, one or more valves may be closed and/or opened to allow water from the feed water side (or brine side) of the membrane to flow back into the water tank. Pressure on the feed side of the membrane will drop to just a few PSI (depending on the height of water in the water tank). As a result, RO flow will stop. Just after this, there is an osmotic potential that drives pure water from clean side of the membrane to the feed side of the membrane. The backflow through the membrane is not driven by the pressure differential (permeate to feed), but by the salinity differential.

The water filtration systems in FIGS. 12-14 may significantly reduce operation cost and the environmental impact of wasted water as compared to conventional RO systems. For example, the systems described in FIGS. 12-14 provide under the sink RO systems that waste less water than conventional RO systems. In some instances, a conventional RO system may waste 70% to 90% of the water processed. The present systems, however, may substantially reduce waste water to about 10% to 30%. Moreover, the water filtration systems in FIGS. 12-14 limit or reduce membrane creep.

Although specific embodiments of the disclosure have been described, numerous other modifications and alternative embodiments are within the scope of the disclosure. For example, any of the functionality described with respect to a particular device or component may be performed by another device or component. Further, while specific device characteristics have been described, embodiments of the disclosure may relate to numerous other device characteristics. Further, although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

1. A water filtration system, comprising:
a first receptacle configured to store source water;
a faucet or dispense actuator;
an RO filter disposed between the first receptacle and the faucet or dispense actuator; and
a bypass line configured to provide water from the RO filter back to the first receptacle for an initial predetermined amount of time, after which the bypass line is closed and the filtered water is provided to the faucet or dispense actuator.

2. The water filtration system of claim 1, wherein the RO filter comprises one or more inverted filters.

3. The water filtration system of claim 2, wherein the inverted filters are attached to a top portion of a filter base.

4. A water filtration system, comprising:
a first receptacle configured to store source water, the first receptacle comprising an outlet port and an inlet port;
a second receptacle configured to store supply water, the second receptacle comprising an inlet port;
a filter system disposed between the first receptacle and the second receptacle, the filter system comprising an inlet port, a first outlet port, a second outlet port, and an RO membrane;
wherein the outlet port of the first receptacle is disposed in fluid communication with the inlet port of the filter system, the first outlet port of the filter system is disposed in fluid communication with the inlet port of the first receptacle, and the second outlet port of the filter system is disposed in fluid communication with the inlet port of the second receptacle;
a flow restrictor disposed between and in fluid communication with the first outlet port of the filter system and the inlet port of the first receptacle;
a first valve disposed between and in fluid communication with the flow restrictor and the inlet port of the first receptacle;
a second valve disposed between and in fluid communication with the second outlet port of the filter system and the inlet port of the second receptacle; and
a bypass line from the second valve to a location downstream of the flow restrictor.

5. The water filtration system of claim 4, wherein the filter system further comprises:
a first filter and a second filter;
wherein the first filter is configured and disposed to receive water from the inlet port of the filter system and to filter and deliver first filtered water to the second filter; and
wherein the second filter is configured and disposed to receive the first filtered water from the first filter, to deliver a first portion of the first filtered water to the first outlet port of the filter system, the first portion of the first filtered water being waste water that is delivered back to the first receptacle, and to filter and deliver a second portion of the first filtered water, the second portion of the first filtered water being second filtered water.

6. The water filtration system of claim 5, wherein the filter system further comprises a third filter, wherein the third filter is configured and disposed to receive the second filtered water from the second filter and to filter and deliver third filtered water to the second outlet port of the filter system.

7. The water filtration system of claim 5, wherein:
the first filter comprises a sediment filter or a combination of a sediment filter and a carbon filter;
the second filter comprises a reverse osmosis membrane or a nano-filter; and
the third filter comprises a carbon filter.

8. The water filtration system of claim 4, further comprising:
a pump disposed between and in fluid communication with the outlet port of the first receptacle and the inlet port of the filter system.

9. The water filtration system of claim 8, wherein the pump is the sole source for generating hydraulic pressure that facilitates fluid flow from the first receptacle through the filter system to the second receptacle, and that facilitates fluid flow from the first receptacle through only a portion of the filter system back to the first receptacle via a flow restrictor.

10. The water filtration system of claim 4, wherein the filter system comprises inverted filters.

11. A method for water filtration, comprising:
filtering water with an RO filter disposed between a first receptacle configured to store source water and a faucet or dispense actuator; and
initially providing the filtered water from the RO filter back to the first receptacle for an predetermined amount of time.

12. The method of claim 11, further comprising after initially providing the filtered water from the RO filter back to the first receptacle for the predetermined amount of time, providing the filtered water to the faucet or dispense actuator.

13. A method for water filtration, comprising:
filtering water with an RO filter disposed between a first receptacle configured to store source water and a faucet or dispense actuator; and
adjusting one or more valves to allow water to flow from the RO filter to the first receptacle to reduce a feed pressure on the RO filter between filtration cycles.

14. The method of claim 13, further comprising inverting the RO filter system.
